(19) United States
(12) Patent Application Publication
(10) Pub. No.: US 2011/0280573 A1
(43) Pub. Date: Nov. 17, 2011

(54) OPTICAL BEAM STEERING

(75) Inventors: Neil Collings, Linton (GB); William Crossland, Harlow (GB); Maura Michelle Redmond, Cambridge (GB); David Nugent, Cambridge (GB); Brian Robertson, Cambridge (GB)

(73) Assignee: CAMBRIDGE ENTERPRISE LIMITED, Cambridge, Cambridgeshire (GB)

(21) Appl. No.: 13/129,045

(22) PCT Filed: Nov. 13, 2009
(86) PCT No.: PCT/GB2009/051537

§ 371 Date: Aug. 1, 2011

(30) Foreign Application Priority Data
Nov. 14, 2008 (GB) 0820867.0
Nov. 14, 2008 (GB) 0820870.4

(51) Int. Cl. H04J 14/02; B23P 17/04; H04J 14/00; G02B 27/00; G02B 5/32

(52) U.S. Cl. 398/48; 349/193; 359/15; 398/83; 29/428

(57) ABSTRACT

This invention generally relates to an optical beam steering apparatus and a method of manufacturing an optical beam steering apparatus, and more particularly to an optical add drop multiplexer (OADM) such as a reconfigurable OADM (ROADM) comprising the optical beam steering apparatus. In one embodiment, the apparatus comprises a slab and a plurality of optical elements in or on a first surface of said slab, the plurality of optical elements including at least one liquid crystal on silicon element, the apparatus being arranged such that at least one optical beam can propagate freely in the slab from one of said plurality of optical elements to another one of said plurality of optical elements via a reflection from a second surface of the optical beam steering apparatus.

### FIELD OF THE INVENTION

This invention generally relates to an optical beam steering apparatus and a method of manufacturing an optical beam steering apparatus, and more particularly to an optical add drop multiplexer (OADM) such as a reconfigurable OADM (ROADM) comprising the optical beam steering apparatus.

### BACKGROUND TO THE INVENTION

Demand for high complexity optical systems, such as optical correlators, and optical interconnects for high performance computing systems, is increasing. In particular, there is demand for optical add drop multiplexers (OADM), and more particularly reconfigurable optical add drop multiplexers (ROADM), for routing between telecommunications ports.

Optical systems using liquid crystals as in display apparatuses may be of relatively high complexity. For example, a colour liquid crystal display (LCD) may have an array of transmissive liquid crystal pixels, each subdivided into red, green and blue sub-pixels, each sub-pixel being capable of being switched between a transmissive and a non-transmissive state and to intermediate (greyscale) states. Further applications of liquid crystal include Liquid Crystal on Silicon (LCOS) in, e.g., projectors.

The field of optical communications continues to provide a need for improved high complexity systems and improved fabrication methods of the same.

For use in understanding the present invention, the following disclosures are referred to:
“High information-content projection display based on reflective LC-on-silicon light valves”, R. L. Melcher, M. Ohhata, K. Enami, J. SID 6/4 (1998) p. 253-256).
“Semiconductor manufacturing techniques for ferroelectric liquid crystal microdisplays”, M. Handschy, Solid State Technology May 2000, 151-161.
“Two-dimensional reconfigurable interconnect in a planar optics configuration”, N. Collings et al., OSA Proceedings on Photonic Switching, H. Scott Hinton and Joseph W. Goodman, eds. (Optical Society of America, Washington, D.C. 1991), Vol. 8, pp. 81-84.
“Reflective liquid crystal wavefront corrector used with tilt incidence”, Zhaoliang Cao, Quanquan Mu, Lifa Hu, Yonggang Liu, Zenghui Peng, and Li Xuan, Applied Optics, Vol. 47, Issue 11, pp. 1785-1789.
“Five-channel surface-normal wavelength-division demultiplexer using substrate-guided waves in conjunction with a polymer-based Littrow hologram”, M. M. Li and R. T. Chen, Opt. Lett. 20, (1995), 797-799.
“Beam Divergence from an SMF-28 Optical Fiber”, Kowalevicz, Andrew M. and Bucholtz, Frank.
“Refractive-diffractive micro-optics for permutation interconnects”, Opt. Eng., Vol. 33, 1550 (1994).
“High efficiency, high dispersion diffraction gratings based on total internal reflection”, Opt. Lett. Vol 29, 542 (2004).
News release by JVC describing a 1.27-inch 4K2K D-ILA Device (http://pro.jvc.com/pro/pr/2007/infocomm/victor_release.html)
Planar-Integrated Free-Space Optical Fan-Out Module for MT-Connected Fiber Ribbons, Matthias Gruber, Journal of Lightwave Technology, vol. 22, No. 9, September 2004, p. 2218
Scaling Properties of Planar Optical Interconnections, J. Jahns, S. Sinzinger, M. Testorf, Fernuniversitat-Hagen
Compact wavelength division multiplexers and demultiplexers, Schechter R., Yaakov Amitai, Friesem A. A., Applied Optics, Vol. 41, No. 7, p. 1256, Jan. 3, 2002.
“Reconfigurable MicroPhotonic add/drop multiplexer architecture”, Ahderom, S. T., Raisi, M., Alameh, K. and Eshraghian, K. in Electronic Design, Test and Applications, 2004, DELTA 2004, Second IEEE International Workshop on 28-Jan. 30, 2004, page(s) 203-207.

### SUMMARY

According to a first aspect of the invention, there is provided an optical beam steering apparatus, comprising: a slab having a first surface; and a plurality of optical elements in or on said first surface of said slab, the plurality of optical elements comprising at least one liquid crystal on silicon element, wherein the optical beam steering apparatus is arranged such that at least one optical beam can propagate substantially freely in the slab from one optical element of said plurality of optical elements to another optical element of said plurality of optical elements via a reflection from a second surface of the optical beam steering apparatus. The slab may be formed of one of glass, ULE 7971, acrylic, silicon, quartz or Borofloat™.

In the above apparatus, the at least one liquid crystal on silicon element may be an array of liquid crystal on silicon elements, and one of more LCOS elements may be a holographic element. Thus, the at least one liquid crystal on silicon element may be an array of pixels, and a finite number of the pixels may be one or more holographic elements. Thus, a hologram comprising a plurality of the LCOS elements, e.g., an array of such LCOS elements, may be provided. ‘Hologram’ as used throughout this specification may be reconfigurable by control of individual LCOS elements within the hologram.

The second surface may be provided as a surface of the slab, that surface being curved to reflect a beam toward one of said elements. Alternatively, a curved mirror may reflect a beam received from the slab toward one of said optical elements on said first surface.

In a further aspect, there is provided an optical add drop multiplexer for optical beam steering, comprising the above optical beam steering apparatus. Thus, the above optical beam steering apparatus may be used to implement an optical add drop multiplexer, which may be reconfigurable.

According to a second aspect of the present invention, there is provided a method of manufacturing the above optical beam steering apparatus, the method comprising: positioning the plurality of optical elements in or on the first surface of the slab using one or more of robotics placement, flip-chip technology and printing, such that light from a predetermined one of said plurality of optical elements can be reflected from the second surface towards another predetermined one of said plurality of optical elements. In one embodiment, a second surface of the slab, from which light is to be reflected back into the slab, may be polished.

The above optical beam steering apparatus may further have: a substrate formed of a semiconductor material; a panel formed of light-transmitting material, the panel being said slab; and a layer of liquid crystal located in a gap defined between said substrate and said panel, wherein: at least at a first region of said substrate, substrate electrical contacts are formed in electrical communication with electronic circuit components formed in or on said substrate; and at least at a first region of said panel, corresponding to said first region of the substrate, panel electrical contacts are formed, wherein said substrate electrical contacts and said panel electrical contacts oppose each other and are electrically connected to each other by a rigid electrical connection.

According to a still further aspect of the present invention, there is provided a reconfigurable optical drop multiplexer for selective wavelength switching in a wavelength division multiplex (WDM) system, comprising: a slab having a plurality of surfaces and having disposed on said surfaces: an input port for receiving an input wavelength division multiplex signal; a wavelength splitter for separating wavelength channels of said input wavelength division multiplex signal; a drop port for transmitting one or more wavelength channels; an output port for transmitting an output wavelength division multiplex signal; and a plurality of liquid crystal on silicon elements arranged to reflect wavelength channels separated by said splitter to the output port and the drop port according to a control signal; and at least one reflecting surface arranged to reflect said wavelength channels of said input wavelength division multiplex signal, wherein: the reconfigurable optical add drop multiplexer is arranged to allow said wavelength channels of said input wavelength division multiplex signal to propagate substantially freely in the slab from the input port to the drop and output ports via said plurality of liquid crystal on silicon elements and the at least one reflecting surface.

In the above reconfigurable optical drop multiplexer, there may further be provided add functionality in the form of an add port for receiving one or more wavelength channels and a combiner for combining those channels with selected channels of the input WDM signal for outputting to the output (express) port. In this way, a ROADM may be implemented. Furthermore, a combiner may be provided in the above reconfigurable optical drop multiplexer to recombine separated wavelength channels, in some embodiments in combination with add channels, for forming the output WDM signal to be propagated through the output port, e.g., into an optical fibre. The liquid crystal on silicon elements may be holographic and may comprise and array or matrix of LCOS elements. Thus, a hologram comprising a plurality of the LCOS elements, e.g., an array of such LCOS elements, may be provided. Similarly as for the optical beam steering apparatus above, the slab may be formed of one of glass, ULE 7971, acrylic, silicon, quartz or Borofloat™, and the reflecting surface may be provided as a surface of the slab, that surface preferably being polished and/or curved. Alternatively, a mirror may be provided as the reflecting surface, the mirror preferably being curved.

According to further aspects, the present invention provides corresponding methods to each of the apparatuses and devices described above, and apparatuses made according to the above described methods, and systems comprising the above apparatuses or devices, or which are implemented using the above method.

Preferred embodiments are defined in the appended dependent claims.

### BRIEF DESCRIPTION OF THE DRAWINGS

For a better understanding of the invention and to show how the same may be carried into effect, reference will now be made, by way of example, to the accompanying drawings, in which:

FIG. 1a shows an embodiment with a variant of a vertically oriented coupling between a single mode fibre connector and a slab;

FIG. 1b shows a further embodiment with a variant of a vertically oriented coupling between a single mode fibre connector and a slab;

FIG. 2 shows a further embodiment with a variant of a vertically oriented coupling between a single mode fibre connector and a slab;

FIG. 3 shows express port coupling between a single mode fibre connector via the slab;

FIG. 4 shows a schematic flow chart and accompanying illustrations of a known flip chip assembly process;

FIG. 5 shows a schematic cross sectional view of a flip chip assembly;

FIG. 6 shows a ROADM comprising a pentaprism; and

FIG. 7 shows a modification of the ROADM comprising a pentaprism.

### DETAILED DESCRIPTION OF PREFERRED EMBODIMENTS

The present invention uses a slab optics approach to optical system construction. As described below, the slab optics approach may advantageously allow design of a system which is both robust and reproducible, and of quantifiable precision. The present invention has been made particularly in view of the realisation that optical systems such as wavelength selective switches, .e.g., ROADMs, can attain a complexity that warrants a slab optics approach as described herein. Thus the apparatus embodiments of an optical beam steering apparatus as described herein may be used to implement a wavelength selective switch.

Specifically, an embodiment allows the placement of elements (e.g., components or devices), which may be position and/or orientation sensitive, on a first (e.g., top) surface of an optical slab. A suitable slab may be, for example, a glass block. A particular optical beam (e.g., a single beam) may then propagate from one element to another via a reflection and possibly further via an intermediate element, all of the successive elements being on the first surface. In other words, at least one optical beam may therefore propagate freely in the slab between elements on the first surface, via reflection from a second surface. (For example, the propagation of a beam between successive devices may be multi-modal within the slab). Such an embodiment may be compared to a system that uses a slab only for propagation of parallel beams.

The second surface may be, e.g., a bottom surface of the slab, or may be a mirror facing the bottom surface of the slab.

Total internal reflection from the second surface means that the slab approach may allow ‘folded optics’, due to the light beam(s) from one element propagating through the slab to be reflected back to a successive element. In particular, beams may be able to use available space more efficiently, particularly in a lateral dimension parallel to the first surface. Thus, the use of slab optics may allow a compact device and/or high complexity, such as in a compact ROADM module scaled to operate with a large number of ports. This may particularly be the case where the first and/or second surfaces are highly polished, as polishing may be particularly effective at reducing the required accuracy of alignment of elements on the top surface and/or reducing the scattering which contributes to insertion loss. Furthermore, the first and/or second surface may have a reflective coating applied.

In order to avoid polarization dependent loss, a polarization diversity technique may be employed whereby the light is split into two orthogonal polarizations and each beam is routed using separate holographic elements on either one or two separate LCOS elements, e.g., using separate holograms each comprising LCOS elements. (For example, a polarization diversity technique may be advantageous when using total internal reflection from the second surface, for example in an embodiment as described above). It is preferable to take account of the polarization dependence of the WDM diffraction and reflectance from the slab faces by TIR or deposited mirrors. Alternatively, the two beams which result from the splitting of the light may be made of the same polarization direction by rotating the polarization in one of the beams by 90 degrees.

In view of the above-described propagation within the slab, waveguide features such as fixed waveguides or optical fibre connections between successive elements may not be needed. This contrasts with other systems that have the disadvantage of requiring waveguides that necessitate additional fabrication steps, e.g., waveguide etching or doping.

An added advantage is that slab optics may help to avoid reflections, since a high level of integration may be possible which reduces the number of physical interfaces, e.g., fibre connectors, that are needed. The reduction in such reflections leads to reduced insertion loss, which may be a critical parameter for a module such as a ROADM. In particular, the use of a slab means that an optical beam path between successive elements may be substantially entirely within the slab, i.e., without any air interface, this reducing the reflection losses at, e.g., connectors and rough surfaces.

The high degree of integration that may be achieved using the slab optics approach may further provide for a more robust device.

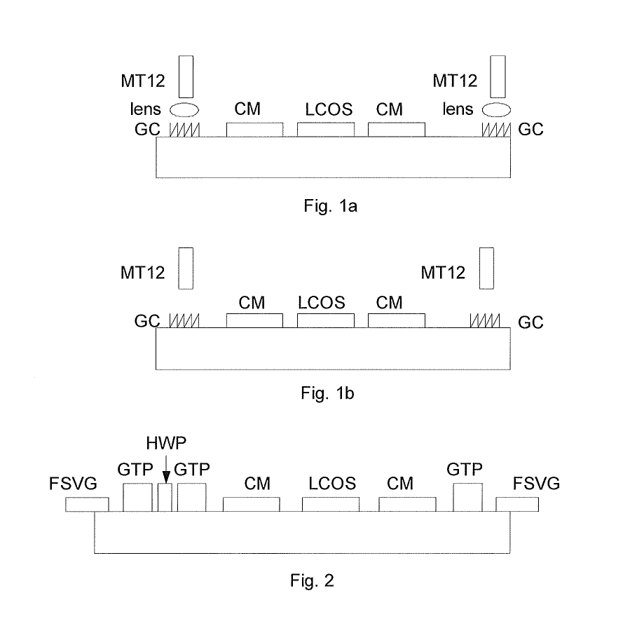

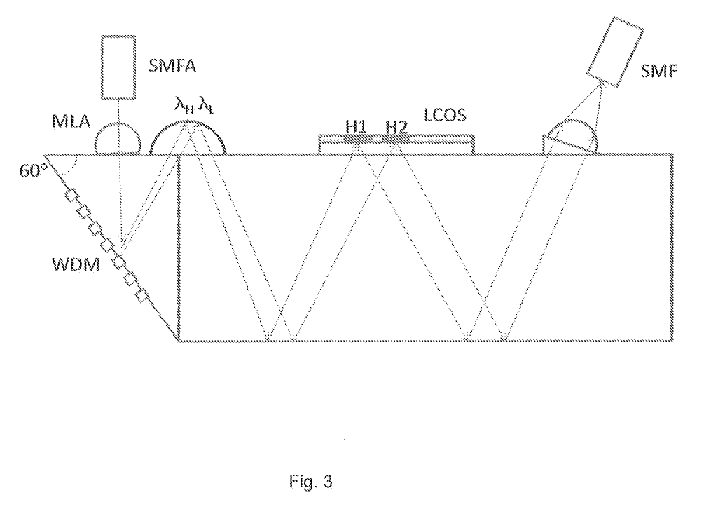

In view of the above, the embodiments of the present invention described herein may be particularly applicable to use in optical communications, e.g., where the slab optics device is designed for operation in the C-band and/or meets stringent requirements of complexity and/or robustness. In contrast, LCOS arrays are more usually used for visible light technologies, rather than in the near-infra-red, infra-red or in optical communications bands as may be achieved with the present invention. In order to render them suitable for C-band telecommunications wavelengths, a thicker LC layer may be used.

Where a separate mirror is not used to provide the second surface of the present embodiment, the slab may be substantially flat to allow total internal reflection from a surface of the slab to reflect the beam back towards a subsequent element on the first surface, i.e., the second surface is a substantially flat surface of the slab. In this case, the slab may advantageously possess a good parallelism of the first and second surfaces, as shown in FIGS. 1a, 1b and 2. Polishing may improve the parallelism between these surfaces.

The use of a curved second surface may have the advantage of allowing the system to be more compact. Therefore, the reflective second surface may be provided as, e.g., a curved and preferably polished bottom surface of the slab. Alternatively, a curved mirror may provide the second surface, if positioned under a substantially unreflecting surface of the slab opposing the first surface, to reflect the beam(s) towards subsequent elements.

The elements placed on the first surface may include at least one liquid crystal over silicon (LCOS) element. LCOS technology relies on reflection rather than on transmission, e.g., in order to provide an image. A LCOS device may have a silicon substrate with suitable integrated circuitry to provide control electronics for an array of pixels. A reflective layer (typically aluminium) may be provided over the control electronics. A layer of liquid crystal above the reflective layer may be controlled in a similar manner to an LCD, to allow each pixel to control, e.g., the intensity of light that is reflected. An upper substrate may be formed from glass, including any required antireflective layers. If the glass is attached to a glass slab using an optical adhesive then there may be no requirement for antireflective layers.

The use of a reflective architecture may allow the use of a silicon (or other semiconductor) substrate. This means that silicon processing techniques may be usable to provide the electronic components for each pixel, so that the pixel size may be made extremely small. In turn, this may allow the formation of very large numbers of pixels on a chip of modest size. The performance of silicon CMOS transistors is much better than that of the thin film transistors used in conventional liquid crystal displays and more complex control circuitry may be included at each sub-pixel. In addition, row and column access circuitry may be included. A LCOS chip size may be around 0.7 inch (about 18 mm) diagonal and may carry 1920×1080 pixels. Additionally, since the light need not pass through the control electronics, it may be possible for LCOS devices to operate more efficiently. The addressing of each pixel in a LCOS device is similar to the row-column addressing in a TFT LCD.

A LCOS chip may have a liquid crystal layer thickness of between 1 and 5 microns.

LCOS chips may be formed using CMOS (complementary metal-oxide-semiconductor) technology. This may allow the formation of very dense arrays of the required electronic components for controlling the pixels, and thus allow the formation of very dense arrays of pixels. LCOS chips may be formed using a modern 90 or 45 nanometre process, for example, or other deep sub-micron silicon CMOS technology.

It is generally advantageous that the spacing between the upper and lower substrates is as uniform as possible across the LCOS device, to achieve a uniform thickness of the liquid crystal layer in the device.

Particularly advantageously, the present embodiment may be scaled to provide an array of LCOS elements for steering a plurality of optical beams. The array may be implemented for example as a reconfigurable (e.g., programmable) optical add drop multiplexer (ROADM) or as a high-capacity optical switch. Such an array may comprise a matrix, e.g., a dense array of millions of elements (pixels) such as LCOS holographic elements, each holographic element being composed of a finite number of pixels (e.g. 32×32) and one element being provided for each wavelength channel. More precisely, a hologram comprising a plurality of the LCOS elements, e.g., an array of such LCOS elements, may be provided as the array. Thus, a highly-scalable OADM operable to steer beams in parallel may be achieved. Each one of a plurality of beams, e.g., each wavelength channel at the slab from an external source, may then be directed to a corresponding element and a hologram element programmed appropriately to steer the corresponding beam as desired.

Furthermore, the slab optics approach may allow the use of improved diffractive optical elements and devices and a complex system such as a ROADM, so providing improved system performance.

In a method embodiment for implementing the above approach, the placement of system elements may be achieved by precision x/y stages rather than active system alignment that generally takes considerable time. In contrast, discrete elements of an optical system generally cannot be assembled together quickly and/or with high accuracy. For example, discrete mirrors may only have a relatively coarse tilt capability that is not suitable for efficiently assembling a compact device. Furthermore, optical systems comprising a kit of such discrete elements, which are generally free-space arrangements, are likely to have long optical path lengths and thus be difficult to miniaturize.

By using precision x/y stages, a slab optics system or device of the present invention may be manufactured with pre-calculated, known path lengths. This may be particularly achievable when accurate placing is achieved by robotic placement and/or printing (e.g., of gratings) of elements on the first surface. In particular, the elements may be automatically aligned so that no further steps are required for alignment and the manufacturing process is low-cost. Thus, low-cost devices may be achievable compared to other technologies where a relatively high number of adjustment blocks are required and these need to be individually set.

Compactness may be further improved by the use of printing in/on a substrate, in embodiments where such printing is used to define elements in/on the first slab surface. Specifically, printing may achieve relatively high-resolution gratings that give high dispersion of wavelengths. Consequently, the wavelengths may be spread across the device/system using smaller path lengths. Thus, a more compact system may be achievable. Printed gratings may be generated by, e.g., nanoimprint lithography. The present slab optics technique may allow printed devices to be implemented in an automatically aligned LCOS device.

Accurate control of optical beam paths and/or element positions on the top surface may be achieved by keeping the optical path in the slab, since the slab may provide a stable medium for light propagation. This may be of particular significance where an embodiment uses off-axis beams (i.e., non-normal incidence on devices) as, for example, off-axis beams of 45 degrees in air may reduce the available phase modulation in a planar aligned device by 30%. A suitable choice of material for the slab, such as those shown in Table 1, may assist in relation to thermal expansion considerations altering ray paths.

Table 1 shows a non-exhaustive list of possibilities for the slab block material. In this regard, it is noted that glass or quartz may be preferred to silicon, since the extra thickness of the slab may allow longer path lengths. The slab is ideally sufficiently thick that the number of reflections can be reduced and the lateral dimension can be kept small. The thickness may be limited by what can in practice be made with good parallel surfaces, particularly when using, e.g., float glass.

TABLE 1

| | | Expansion | Thermal | |
|---|---|---|---|---|
| | | Coefficient | Conductivity | Specific Heat |
| Slab material | Thickness | (PPM/deg) | (W/M/Deg C.) | (J/Kg/Deg C.) |
| Plate Glass | 7 mm | 9 | 0.75 | 730 |
| ULE (TM) | | 0.06 | 1.3 | 780 |
| 7971 | | | | |
| Cast acrylic | 50 mm | 70 | 0.18 | 1400 |
| Silicon | 0.38 mm | 2.6 | 130 | 700 |
| Schott | 25 mm | 3.2 | 1.2 | 830 |
| Borofloat | | | | |
| (TM) 33 | | | | |

The use of Corning ULE™ 7971 is particularly advantageous, since this material may have a thermal expansion one hundredth that of glass, i.e., 0.06 ppm/deg C (Table 1).

Alternatively, Borofloat™ sheet may be used. In such an embodiment, an expansion of 3 ppm over a 10 degree rise means that the thickness of the 25 mm borofloat sheet may increase by one or two wavelengths, which may be within the placement accuracy of elements on the slab.

Path length changes due to temperature fluctuations may be further or alternatively overcome by adjusting the hologram element on the LCOS to account for the path length changes, e.g., using the programmability of the LCOS.

Since the LCOS is tunable, LCOS may be usable to compensate for beam path changes such as those due to temperature fluctuations. This may be combined with the programming of the LCOS to achieve the desired beam steering.

Embodiments of the present invention may use LCOS as shown in, for example, FIGS. 1a, 1b and 2. The LCOS is placed on a slab, e.g., of glass or quartz. One particular way of mounting the LCOS on the slab may be to use flip-chip technology, with natural alignment using solder in the molten state. A particularly advantageous technique is to use, in combination, the robotics placement of discrete elements on the slab and flip-chip technology, and optionally printing on the slab itself to form devices such as gratings.

As for all of the apparatus embodiments described herein, the provision of a LCOS array, e.g., a plurality of individual LCOS holographic elements, on such a slab may allow a low-cost, high-density beam steering array to be provided.

The embodiments shown in FIGS. 1a, 1b may provide vertically oriented coupling between MT12 twelve single mode fibre connector and a slab. FIG. 2 is a related variant.

In FIGS. 1a and 1b, light is coupled between the slab and an MT12 connector by means of a grating coupler (GC) and a lens. A grating coupler may allow the beam to be spread, e.g., the coupler may spread wavelengths from fibres that provide the input light of the optical beam steering device. The grating coupler may be used to launch the light at the correct angle into the slab, and this may be combined with wavelength spreading. The output grating coupler may combine the wavelengths and correct the angle to allow coupling into the optical fibre.

In FIG. 2 shows that the input and/or fibres may be mounted using Fibres on Silicon V-grooves (FSVG). This may have the advantage of providing a reliable join without damaging the fibre or slab (e.g., silicon).

FIGS. 1a, 1b and 2 show that elements placed on the top surface of the slab may include a converging mirror (or diffractive lens-type element) (CM) and/or a Liquid Crystal on Silicon (LCOS), e.g., a LCOS programmable diffraction grating.

An active beam deflector may be applied in a slab optics design, for example for a grating demultiplexer. In particularly, an embodiment may provide an ROADM implemented with slab optics, advantageously in conjunction with flip-chip bonding of LCOS.

According to a detailed fabrication method embodiment, which may be suitable to fabricate an optical beam steering apparatus as shown in FIG. 3, a uniform slab of glass (e.g., 25 mm thickness Schott Borofloat 33) with estimated index of refraction at 1550 nm 1.456 may be used, so that the limiting angle for total internal reflection (TIR) is 43.4 deg. Edges are prepared with a bevel or by gluing a prism onto a straight edge using optical adhesive. The angle of the bevel is calculated according to the design of the wavelength demultiplexing grating (WDM) or hologram which is fabricated on that edge.

An MT12 fibre ribbon connector populated with Coming SMF28 may be mounted vertically using the two pins on the connector inserted into holes drilled into the borofloat glass. A beam exiting a Corning SMF28 at 1550 nm may be Gaussian with beam waist 5.25 microns with a beam divergence angle of 100 mrad.

Microlenses are mounted on the borofloat substrate so that the divergence angle of the beams from the fibres is reduced. It is advantageous to use a large aperture microlens so that the propagation length of the beam is sufficient for a reflected path in the slab. One advantage of using the glass substrate may be that the refractive index of the slab reduces the divergence of the beam and allows longer interconnection lengths for a given geometry. The maximum propagation length for a microlens based interconnection may be IIω²/λ. Therefore, for a 3 cm double pass in the slab at 1.55 micron wavelength, a beam waist radius of 100 micron may be required at the microlens. In order to reduce or avoid beam clipping, the side of the rectangular aperture of the microlens is made 300 micron (or larger). Therefore, the MT12 connector may be populated with 6 fibres at an interfibre spacing of 500 micron. It is advantageous if the microlens is 300 micron diameter because the beam waist (flat phase front) may then fall at the wavelength demultiplexer grating (WDM). The demultiplexer may split the wavelengths with high dispersion and efficiency. For example, TIR gratings may provide near to 100% efficiency for both TM and TE polarizations over a 20 nm bandwidth. For these high efficiencies, the incident and diffracted beams are advantageously at angles satisfying the TIR condition. Therefore, the grating may be designed so that the m=−1 diffracted order is reflected close to the Littrow condition, as shown in FIG. 3. This requires a sub-wavelength grating which is etched into the borofloat glass by a standard procedure.

In a device made according to the above detailed fabrication method, if the edge of the slab is bevelled at 60 deg, then the light from the microlens will be incident on the WDM at 60 degrees. A TIR grating with −1 diffraction order at 45 degrees will give a dispersion in the substrate of around 1 mrad/nm. This −1 order propagates to the top surface of the slab where a top silver coated planoconvex lens, e.g., a silver coated planoconvex microlens or silver coated planoconvex cylindrical lens, has been glued to the slab. The beam is reflected from the silver surface and continues its zigzag propagation within the slab, reflecting from silver mirror on the bottom surface and either silver mirror or silver coated planoconvex lens (e.g., the above microlens or cylindrical lens) on the top surface until the dispersion has separated the beams such that they have a sufficient separation on the LCOS device. A sufficient separation may be that which allows each wavelength channels (separated from the other channels by 0.4 nm) to have an area of pixels on the LCOS of, e.g., 32×32 or 500×3 pixels, where a deflection hologram is written. For example, if 32 pixels on a LCOS device covers 218 μm, and the angle between two neighbouring channels diffracted from the TIR hologram is 0.4 mrad, the required propagation distance is 545 mm. Alternatively, where the separation allows the area of pixels on the LCOS of 500×3, the required propagation distance may be 51 mm, which may be just a double bounce in the 25 mm Borofloat substrate. This distance may be reduced by either using additional WDM or retroreflecting onto the same WDM so that the dispersion is increased at each reflection. Increasing the dispersion may reduce the propagation distance for sufficient channel separation.

Each channel may have its own dedicated real estate on the LCOS device. The beam can be either specularly reflected or diffracted by a specially designed hologram. If holograms are selected for the channels such that neighbouring channels are deflected in increments of 0.4 mrad, then the wavelength channels may be propagating collinearly and may be collected by a large aperture lens and focussed onto the end of a single mode fibre.

The above corresponds to the functionality of a ROADM that is not dropping any channel, but sends all the wavelength channels to the output (Express) port. Dropping of a channel may occur when a hologram addressed to the channel's real estate diffracts the channel to a different location on the slab and thence to a different single mode fibre.

In order to implement channel monitoring, the hologram may be designed so that a small percentage of the total light diffracted is directed towards the fibre output which is used for monitoring.

In order to implement multicasting, the holograms may be such that equal amounts of each channel go to each of the selected output channels. Adding a channel occurs when the real estate diffracts the light to the same angle as those beams propagating to the express port.

Deflection holograms may be designed for high efficiency deflection, multicasting or splitting with a ratio (e.g., 90% deflection with 10% into a monitoring channel), by simulated annealing. In particular, the simulated annealing can be performed on the optical system, for optimal diffraction efficiencies.

FIG. 3 shows Express port coupling between MT12 twelve single mode fibre connector via the slab. This embodiment involves a single mode fibre array (SMFA), a microlens array (MLA), a wavelength demultiplexing grating (WDM) and a LCOS programmable diffraction grating with H1 and H2 beam deflecting holograms.

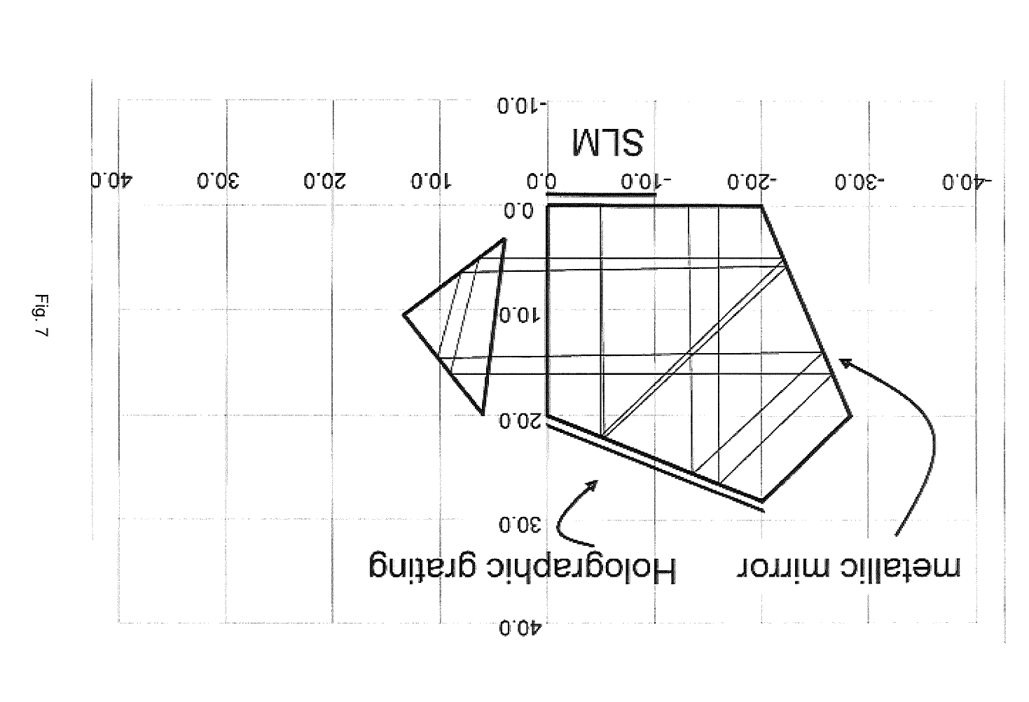

A further embodiment is a ROADM comprising a pentaprism as shown in FIG. 6. All three optical components are commercially available: PentaPrism (Edmund Optics B49-010), Right angle prism (Edmund Optics B49-413), and reflective holographic grating (Newport Master 5190). The SLM (Spatial Light Modulator) has been programmed to induce a 1° change in the reflected angle. Due to the long path length (172 mm after the SLM) this results in a 2.9 mm deviation in the exiting beam relative to the incoming beam.

FIG. 6 does not show lateral displacement polarising beamsplitters (Edmund Optics B47-540), quarter wave plates (P [symbol] S polarisation), or focussing optics. The location and focal lengths of the latter depend on the incoming optical assemblies.

Advantages of the FIG. 6 embodiment may include any one or more of the following:
Compact: This device, which is only 3 cm×4 cm, may diffract the entire C-band into a 1-cm “rainbow” across the SLM facet. This is small.
Normal incidence on SLM: the full angular range of phase-controlled beam deflection off the SLM is available for wavelength or/and fiber switching. There is no need to bias the SLM to compensate for angular deviations.
Normal incidence on glass facets: light beams enter and exit both the penta prism and right angle prism at or very near 90° to their respective facets. This is advantageous over non-normal incidence since it minimises diffraction offsets caused by temperature-induced changes in the glass's refractive index. This will meaningfully reduce the temperature sensitivity of the system. Furthermore, normal incidence means any anti-reflection coatings may be effective over a wider range of wavelengths than otherwise would have been the case.
Internal reflections: all reflections are performed by internal reflections off coated gold facets. This may mean they are less sensitive to environmental damage.
Positional and angularly insensitivity: the direction of incoming and outgoing beams are unaffected by the lateral (y-axis), longitudinal (x-axis), or angular rotation of the right angle prism. Consequently the manufacturing and alignment tolerances are very high indeed. This is unlike planar mirrors where changes to the angle of incidence would need to be compensated for by biasing the SLM, which in turn would reduce the dynamic range of wavelength and fiber switching.
Arbitrary sensitivity: the sensitivity of the ROADM is arbitrarily controlled by the distal position of the right angle prism from the SLM surface. Pushing the reflector further from the penta prism increases the sensitivity, and vice versa.
High angular dispersion: the angular dispersion, defined here as the rate of change of angle with change in wavelength, is defined by the equation:

$$\frac{Δ θ}{Δ λ} = \frac{m}{d cos θ}$$

where m=grating order and d=grating periodicity. Since incoming WDM signals hit the diffraction grating at θ=67° 30′ this may mean the angular dispersion is 2.6 times larger than at normal (θ=0°.
High reflectivity off grating: Newport Corporation (Richardson Gratings, 705 St. Paul Street, Rochester, N.Y. 14605, USA;http://www.newport.com/) makes a range of reflective holographic gratings whose S-plane efficiencies are >94%. By contrast the P-plane efficiency is <10% in the C-band range. This means stray P-plane polarised light may be scattered quickly out of the structure. In this regard, we refer to Newport Corporation product Master 5190, Catalog No. 53-̂-544H, diffraction order 1, goorve frequency, 1100 g/mm, grating type plane holographic, coating aluminum, modulatino hig, recommended spectral range 400-1.7 um, the S-plane and P-plane efficiency curves (efficiency—% versus wavelength—um) can be found at http://gratings.newport.com/products/efficiency/effFrame.asp?sku=020|53-*-544H.
Diffraction grating: the diffraction grating shown above covers the entire length of the PentaPrism. This way the light is diffracted four times on its passage through the structure (twice before the SLM and twice after the SLM). However, by limiting the size of the grating it may be possible to reduce the number of diffraction/reflections to two.
SLM position tuning: the central position of the diffracted light can be tuned across the SLM facet by rotating slightly the angle of the reflective prism. This is illustrated in FIG. 7. Here we have rotated the prism by 7°, causing the reflected beam to hit the SLM centrally instead of towards the left side. Comparing this diagram with FIG. 6, also note this rotation and SLM offsetting does not affect the position of the exciting beam. Overall, the diffracted WDM spectrum and SLM can be aligned by simply rotating the reflective prism.

As mentioned above, flip-chip bonding may be used to mount one or more LCOS elements on a slab in any embodiment of the present invention. In this manner, a ROADM may be implemented with slab optics. One particular flip-chip bonding technique is now described with general reference to liquid crystal devices and methods for their manufacture. In particular, and merely in order to assist understanding of how the technique may be applied to the present invention, the flip-chip bonding technique is described in relation to bonding of LCOS elements in display devices.

Flip-chip technology is a known technology from integrated circuit manufacturing and packaging. In this technology, integrated circuit chips are provided with metallized contact pads with electrical contact bumps (typically solder bumps) formed on the contact pads. These are electrically connected to a printed circuit board (for example) by placing the solder bumps into contact with corresponding contact pads on the printed circuit board, melting the solder and allowing a rigid electrical connection to form between the integrated circuit chip and the printed circuit board. The term “flip-chip” comes from the inversion of the relative orientation of the integrated circuit chip and the printed circuit board compared with conventional wire bonding.

The reader is referred to a general textbook on flip chip packaging of microelectronic devices: “Low Cost Flip Chip Technologies: For DCA, WLCSP, and PBGA Assemblies” by John H. Lau (McGraw-Hill Professional, 2000, ISBN 0071351418).

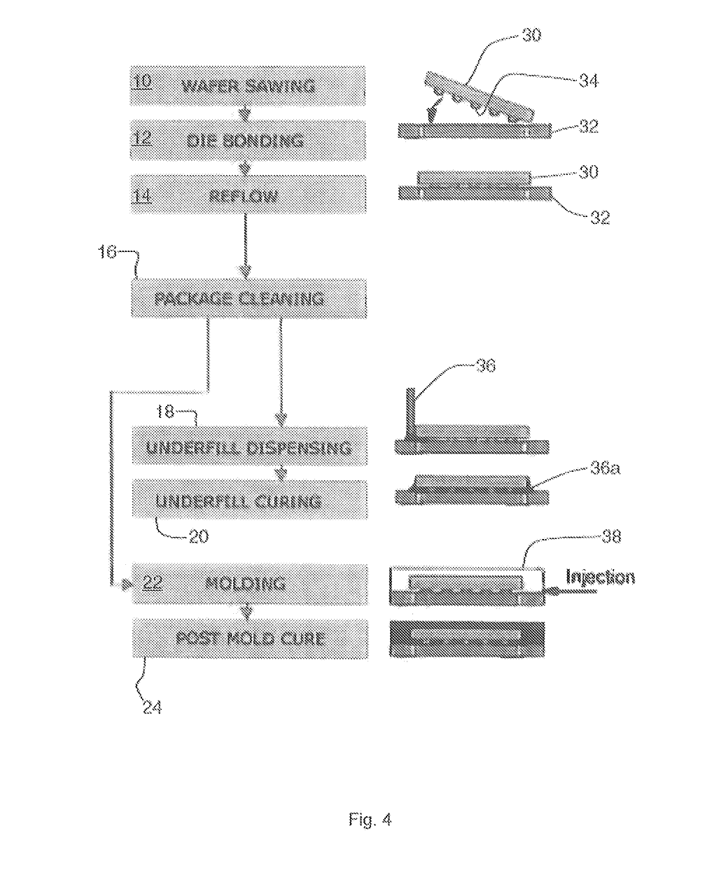

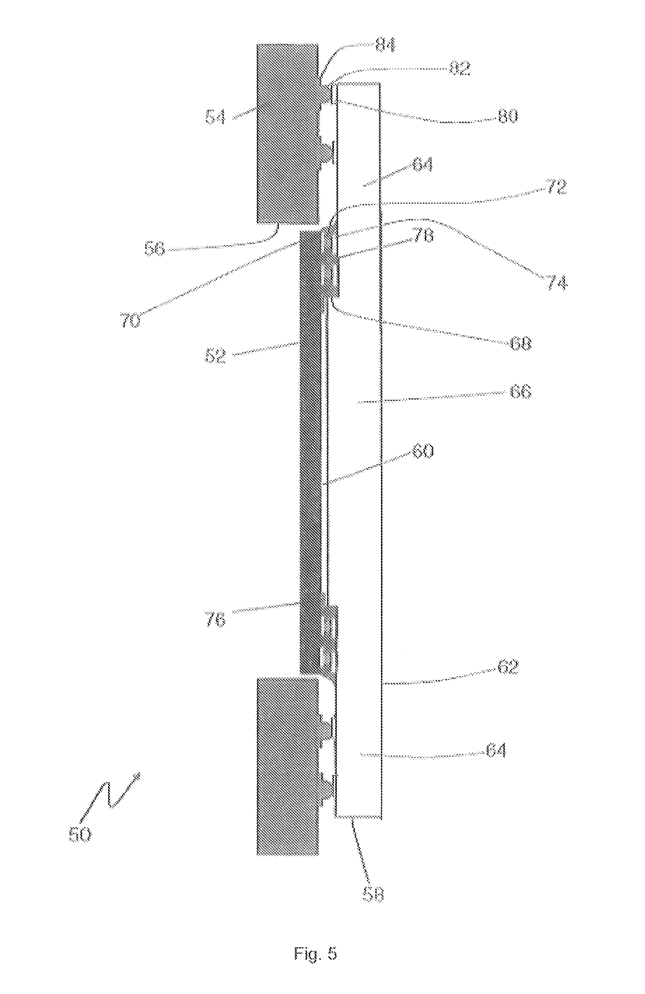

FIG. 4 shows a schematic flow chart and accompanying illustrations of a known flip chip assembly process. The steps of the process are numbered 10-24. An array of integrated circuit devices is formed by steps not shown on a wafer which is then sawn or diced at step 10 to form integrated circuit chip 30. Chip 30 is then electrically connected to circuit board 32 via solder bumps 34 at steps 12 and 14, by re-melting the solder bumps 34, e.g. using ultrasound. The assembly of chip 30 and circuit board 32 is then cleaned at step 16.

Typically, the next step is an underfill step. The assembly of the chip 30 and circuit board 32 provides a small gap between them. An underfill material 36 is dispensed into this small gap at step 18 and allowed to cure at step 20 to form cured underfill layer 36a.

In an alternative process, the underfill steps 18, 20 are replaced by molding steps 22, 24. The assembly of chip 30 and circuit board 32 is placed into a corresponding mold 38 and molding material is injected into the mold to surround chip 30. The molding material is allowed to cure at step 24 to provide an encapsulated chip.

In the underfill process and in the molding process, the cured underfill material or molding material, respectively, provides an improved mechanical connection between the chip and the circuit board compared with the solder alone.

The above flip-chip processes may be used to fabricate a LCOS device/system of the present invention if the circuit board 32 is substituted by the slab, e.g., glass block.

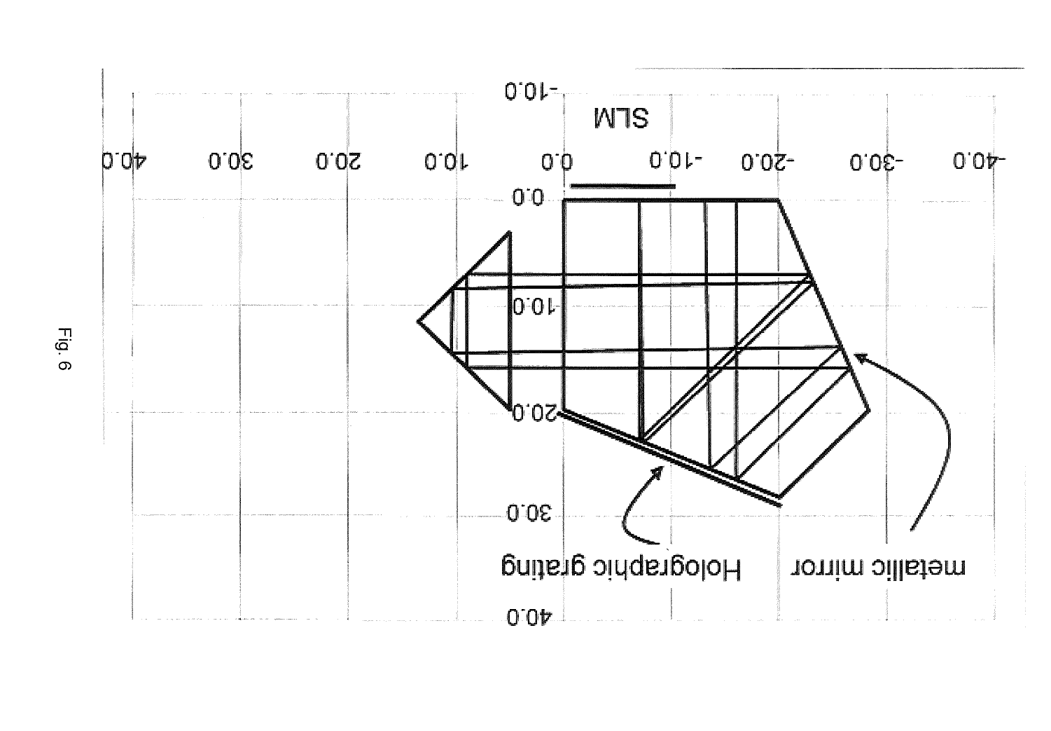

An alternative technique for flip-chip bonding described below in relation to FIG. 5 is broadly applicable to the mounting of LCOS on a slab for producing a device/system according to the present invention. In this case, the panel 58 as referred to below is substituted by a slab as in the present invention. Furthermore, the circuit board 54 may be omitted in an embodiment of the present invention. However, the circuit board 54 may be used to interface programmable elements of the present invention, e.g., a programmable LCOS array, to external electrical control apparatus. Furthermore, if the circuit board is omitted, then the stepped profile of the peripheral and central regions 64, 66 may be omitted.

FIG. 5 shows a schematic cross sectional view of part of a packaged LCOS device 50. Substrate 52 is formed from a silicon wafer and includes control electronics for sub-pixels (described below), the control electronics being formed via a deep submicron process, e.g. 90 nanometre or 45 nanometre CMOS process. Substrate 52 is located within an aperture 56 formed in circuit board 54. A heat sink or Peltier cooler (not shown) may be placed in thermal contact with substrate 52 in order to assist in thermal management of the LCOS device. In the presently described arrangement, it is not necessary for the substrate 52 to be directly attached to circuit board 54. However, other arrangements may omit aperture 56 and allow the substrate to be mechanically attached to circuit board 54. Circuit board 54 provides electrical connections for connecting the LCOS device to an electronics interface (not shown)

A light-transmissive glass or quartz panel 58 is provided over the forward surface of the substrate 52, defining gap 60 between the forward surface of the substrate and a rearward surface of the panel 58. Liquid crystal is located within gap 60 in a known manner for LCOS devices.

Light-transmissive panel 58 has a flat forward surface 62. However, its rearward surface has a stepped profile, providing a first, peripheral region 64 of a first thickness and a second, central region 66 of a second thickness, the second thickness being greater than the first thickness. The difference in thickness is provided by step 68, which is formed by etching the rearward surface of the light-transmissive panel. The second, central region 66 of the panel is in contact with the liquid crystal layer 60 via a transparent electrode such as ITO.

Substrate 52 has peripheral metallized pads 70 on which are formed solder bumps 72 in a manner known from flip chip processing. Metallized pads 70 may be formed from Cr—Au. During manufacture of the LCOS device, substrate 52 is located in opposed relation to light-transmissive panel 58 so that solder bumps 72 are at least approximately in register with corresponding metallized pads 74 on the first, peripheral region 64 of the light-transmissive panel 58. Metallized pads 74 may be formed from Cr—Au, in which a layer of Cr is formed in contact with the glass panel and the layer of Au is formed over the Cr. At this stage, gap 60 is not yet filled with liquid crystal, but spacer member 76 is located at the periphery of the second, central region 66 of the panel in gap 60. The solder bumps are then subjected to ultrasonic reflow. The surface tension effects of the molten (or partially molten) solder bumps in contact with the metallized pads 74 causes the substrate 52 and panel 58 to align themselves to reach a mutual alignment having a low energy configuration. Thus, if the substrate 52 and panel 58 were slightly out of alignment at the start of the process, the reflow step brings them into satisfactory alignment. The solder is then allowed to solidify to form rigid electrical connections between substrate 52 and panel 58.

Using known flip chip processing, the spacing of gap 60 can be very precisely controlled, typically in the range 1-20 μm and preferably in the range 2-5 μm. This is a surprising result for LCOS devices, since the uniformity of the width of gap 60 is of critical importance to the performance of the LCOS device, for the reasons explained above, and so the application of flip-chip technology to LCOS devices provides a surprisingly effective and efficient route for the mass manufacture of LCOS devices. The spacing of the gap between the substrate 52 and the first, peripheral region 64 of the panel 58 after the reflow process is typically greater than 20 μm, e.g. about 100 μm or greater. Therefore the height of step 68 is typically at least 15 μm, and is normally about 95 μm or greater.

The silicon substrate 52 typically has a thickness of between 0.25 mm to 0.38 mm (10 thou to 15 thou). The light-transmissive panel 58 typically has a thickness, prior to etching, of between 0.7 mm to 2 mm.

The forward face of the light-transmissive panel has a series of antireflective coatings (ARC) formed on it, in a manner known for LCOS devices.

After the reflow process, the assembly of the substrate and the panel is subjected to an underfilling process. Underfill material 78 is flowed into the space between the substrate and the first, peripheral region 64 of the panel. The underfill material is substantially prevented from entering gap 60 by spacer member 76. At least one conduit (not shown) is kept open into space 60 in order that the liquid crystal can be filled into space 60 after curing of the underfill material 78. Spacer member 76 should preferably be formed of a material that is compatible with the liquid crystal, and may be formed of a typical seal material for LCOS devices.

The metallized pads 74 on the first, peripheral region 64 of the panel 58 are connected via tracks to further metallized pads 80. In the present arrangement, these pads 80 are electrically connected to corresponding pads 84 on the circuit board 54 via solder bumps 82. This is via a similar flip chip process to that described above. However, in another arrangement, it is possible for the electrical connections between the panel 58 and the circuit board 54 to be formed by wire bonding techniques.

The mechanical attachment between the panel 58 and the circuit board 54 may be supplemented by underfilling, as already described with respect to the substrate 52 and panel 58. However, the underfill material between the panel 58 and the circuit board 54 is not shown in FIG. 5.

It is further possible to use precision spacers between the substrate 52 and panel 58 in order to ensure excellent uniformity of the width of the gap 60. This is particularly applicable to large-formal LCOS devices.

The above device of FIG. 5 was made considering that, if there is thickness non-uniformity in conventional liquid crystal displays, then there will be a non-uniformity in the electro-optic response of the liquid crystal and a colour shift. In earlier twisted nematic displays, colour dispersion was minimised by the waveguiding of the polarization direction of the light through the twisted structure. More modern conventional displays (which for instance may use a vertically aligned nematic structure, VAN) and also the phase-only holographic displays that are made possible by LCOS do not use such twisted structures. Holographic projection displays or beam deflector devices based on LCOS may need an accurately controlled thickness so the retardation is uniformly 2π when no hologram is displayed. If this is not achieved then light is directed into a zero order spot which for nematic liquid crystal devices is in the centre of the image. In these instances a target thickness uniformity would be between 100 and 200 nanometres (or better if possible). This may be a very stringent requirement.

LCOS devices and manufacturing methods in the prior art may be improved, or at least altered, in order to provide useful results in terms of efficiency of manufacture and/or performance in the resultant devices. In particular, certain aspects of flip-chip technology can be combined with LCOS technology to provide useful results.

The following describes one improved liquid crystal device. The device has a substrate formed of a semiconductor material, a panel formed of light-transmitting material and a layer of liquid crystal located in a gap defined between said substrate and said panel, wherein at least at a first region of said substrate, substrate electrical contacts are formed in electrical communication with electronic circuit components formed in or on said substrate, and at least at a first region of said panel, corresponding to said first region of the substrate, panel electrical contacts are formed, wherein said substrate electrical contacts and said panel electrical contacts oppose each other and are electrically connected to each other by a rigid electrical connection. The following describes one improved method of manufacturing a liquid crystal device having a substrate formed of a semiconductor material, a panel formed of light-transmitting material and a layer of liquid crystal located in a gap defined between said substrate and said panel. At least at a first region of said substrate, substrate electrical contacts are formed in electrical communication with electronic circuit components formed in or on said substrate, and at least at a first region of said panel, corresponding to said first region of the substrate, panel electrical contacts are formed, the method including the steps of placing the substrate electrical contacts and the panel electrical contacts in opposition to each other and electrically connecting the substrate electrical contacts and the panel electrical contacts via a rigid electrical connection.

Thus, it is possible to provide reliable electrical contacts between the substrate and external components, whilst at the same time providing a well-defined and uniform thickness to the liquid crystal layer in the device.

Regarding the above general textbook by John H. Lau, it is noted that the highly developed flip-chip technology can be applied to LCOS devices to provide the surprising combined advantages of good alignment between the contacts on the panel and the substrate, robust physical connection between the panel and the substrate, and a highly uniform thickness of the gap between the panel and the substrate, and hence for the layer of liquid crystal.

The first region of the panel may be a peripheral region. This may extend around the periphery of the panel.

Preferably, a spacer member is formed between the layer of liquid crystal and the first region of the substrate and the first region of the panel. The spacer member preferably assists in sealing of the layer of liquid crystal within the device.

An underfill material is preferably provided to encapsulate, at least partially, the substrate electrical contacts and the panel electrical contacts. This material is preferably a cured material. The underfill material my be applied in liquid, uncured form, and subsequently allowed to cure.

The panel preferably has a second region located in correspondence with the layer of liquid crystal. This second region is preferably at a central part of the panel.

The shortest distance between the substrate and the surface of the first region of the panel is typically greater than the shortest distance between the substrate and the surface of the second region of the panel. The gap in which the liquid crystal is located is typically the distance between the substrate and the surface of the second region of the panel. The width of the gap is preferably at least 1 μm. More preferably, the width of the gap is at least 2 μm. The width of the gap is preferably at most 20 μm, and is more preferably at most 15 μm, or at most 10 μm or at most 5 μm.

The spacing of the gap between the substrate and the first region of the panel in the finished device is typically greater than 20 μm, or greater than 50 μm. A preferred range for this spacing is 100 μm or greater.

Preferably a step is formed in a transition region of the panel between the first and second regions. The height of the step is typically at least 5 μm, more preferably at least 10 μm, more preferably at least 20 μm, more preferably at least 40 μm, more preferably at least 60 μm, more preferably at least 80 μm, or about 100 μm or greater.

Preferably the semiconductor substrate has a thickness of at least 0.2 mm. This thickness is preferably at most 1 mm. Preferably the panel has a thickness of at least 0.5 mm, measured at the second region. This thickness is preferably at most 5 mm, or more preferably at most 2 mm.

Preferably the spacer member is located between the substrate and the second region of the panel. Preferably the underfill material is substantially prevented from reaching the second region of the panel by the spacer member.

Preferably the substrate and panel are each substantially rectangular (or square) in shape. It is preferred that the first region of the panel extends around at least two sides of the rectangle.

Preferably the rigid electrical connection is formed by fusing. The rigid electrical connection may be a fused solder bump connection.

Preferably the electrical contacts on the panel are electrically connected to a carrier member. The electrical connection between the electrical contacts on the panel and the carrier member is preferably via a rigid electrical connection.

The carrier member may have an aperture located in register with the substrate. A heat sink and/or cooling means may be provided in contact with the substrate, via said aperture.

During manufacture of the device, in the step of electrically connecting the substrate electrical contacts and the panel electrical contacts, the substrate electrical contacts may initially be placed at least partly out of register with the panel electrical contacts. During the formation of the electrical connection, the respective contacts may come into register.

Preferably, the liquid crystal material is filled into the gap between the substrate and the panel after electrically connecting the substrate electrical contacts and the panel electrical contacts.

The liquid crystal material may be a vertically aligned nematic liquid crystal.

Preferably, the underfill material is caused to encapsulate, at least partly, the substrate electrical contacts and the panel electrical contacts. Preferably, the liquid crystal material is filled into the gap between the substrate and the panel after the underfill material is caused to encapsulate, at least partly, the substrate electrical contacts and the panel electrical contacts. The liquid crystal material may be allowed to fill the gap between the substrate and the panel through at least one aperture in the underfill material. The aperture may be sealed thereafter.

The panel may be processed by etching to provide a difference in height between the first and second regions of the panel.

Regarding the above description of a flip-chip device in relation to FIG. 5, the device and process can be summarized as in E1-E27 below.

E1. A liquid crystal device having: a substrate formed of a semiconductor material; a panel formed of light-transmitting material; and a layer of liquid crystal located in a gap defined between said substrate and said panel, wherein: at least at a first region of said substrate, substrate electrical contacts are formed in electrical communication with electronic circuit components formed in or on said substrate; and at least at a first region of said panel, corresponding to said first region of the substrate, panel electrical contacts are formed, wherein said substrate electrical contacts and said panel electrical contacts oppose each other and are electrically connected to each other by a rigid electrical connection.

E2. A liquid crystal device of E1, wherein a spacer member is formed between the layer of liquid crystal and the first region of the substrate and the first region of the panel, in order to assist in sealing of the layer of liquid crystal within the device.

E3. A liquid crystal device of E1 or E2, wherein underfill material is provided to encapsulate, at least partially, the substrate electrical contacts and the panel electrical contacts.

E4. A liquid crystal device of any one of E1 to E3 wherein the panel has a second region located in correspondence with the layer of liquid crystal, the shortest distance between the substrate and the surface of the first region of the panel being greater than the shortest distance between the substrate and the surface of the second region of the panel.

E5. A liquid crystal device according to E4 wherein a step is formed in a transition region of the panel between the first and second regions.

E6. A liquid crystal device according to E4 or E5 wherein the shortest distance between the substrate and the surface of the first region of the panel is 20 μm or greater.

E7. A liquid crystal device according to E4 or E5 wherein the shortest distance between the substrate and the surface of the first region of the panel is 100 μm or greater.

E8. A liquid crystal device according to any one of E4 to E7 wherein the shortest distance between the substrate and the surface of the second region of the panel is less than 20 μm.

E9. A liquid crystal device according to any one of E4 to E8, having the features of E2, wherein the spacer member is located between the substrate and the second region of the panel.

E10. A liquid crystal device according to any one of claims 4 to 9 wherein the underfill material is prevented from reaching the second region of the panel by the spacer member.

E11. A liquid crystal device according to any one of E1 to E10 wherein the substrate and panel are substantially rectangular in shape and the first region of the panel extends around at least two sides of the rectangle.

E12. A liquid crystal device according to any one of E1 to E11 wherein the rigid electrical connection is formed by fusing.

E13. A liquid crystal device according to any one of E1 to E12 wherein the rigid electrical connection is a fused solder bump connection.

E14. A liquid crystal device according to any one of E1 to E13 wherein the electrical contacts on the panel are electrically connected to a carrier member.

E15. A liquid crystal device according to E14 wherein the electrical connection between the electrical contacts on the panel and the carrier member is via a rigid electrical connection.

E16. A liquid crystal device according to E14 or E15 wherein the carrier member has an aperture located in register with the substrate.

E17. A liquid crystal device according to E16 wherein a heat sink and/or cooling means is provided in contact with the substrate, via said aperture.

E18. A method of manufacturing a liquid crystal device having: a substrate formed of a semiconductor material; a panel formed of light-transmitting material; and a layer of liquid crystal located in a gap defined between said substrate and said panel, wherein at least at a first region of said substrate, substrate electrical contacts are formed in electrical communication with electronic circuit components formed in or on said substrate, and at least at a first region of said panel, corresponding to said first region of the substrate, panel electrical contacts are formed, the method including the steps: placing the substrate electrical contacts and the panel electrical contacts in opposition to each other; and electrically connecting the substrate electrical contacts and the panel electrical contacts via a rigid electrical connection.

E19. A method according to E18 wherein, in the step of electrically connecting the substrate electrical contacts and the panel electrical contacts, the substrate electrical contacts are initially placed at least partly out of register with the panel electrical contacts, the respective contacts coming into register during the formation of the electrical connection.

E20. A method according to E18 or E19 wherein the liquid crystal material is filled into the gap between the substrate and the panel after electrically connecting the substrate electrical contacts and the panel electrical contacts.

E21. A method according to any one of E18 to E20 wherein an underfill material is caused to encapsulate, at least partly, the substrate electrical contacts and the panel electrical contacts.

E22. A method according to E21 wherein the liquid crystal material is filled into the gap between the substrate and the panel after the underfill material is caused to encapsulate, at least partly, the substrate electrical contacts and the panel electrical contacts.

E23. A method according to E22 wherein the liquid crystal material is allowed to fill the gap between the substrate and the panel through at least one aperture in the underfill material, the aperture being sealed thereafter.

E24. A method according to any one of E18 to E23 wherein the panel has a second region corresponding to the layer of liquid crystal, the shortest distance between the substrate and the surface of the first region of the panel being greater than the shortest distance between the substrate and the surface of the second region of the panel, the panel being formed via etching to provide a difference in height between the first and second regions.

E25. A method according to any one of claims 18 to 24 wherein solder bumps are formed on the substrate electrical contacts.

E26. A method according to any one of E18 to E25 further including the step of electrically connecting the panel electrical contacts to a carrier member via a rigid electrical connection.

E27. A method according to E26 wherein solder bumps are formed on carrier member electrical contacts.

No doubt many other effective alternatives embodiments of the present invention will occur to the skilled person. It will be understood that the invention is not limited to the described embodiments and encompasses modifications apparent to those skilled in the art lying within the spirit and scope of the claims appended hereto.

1. An optical beam steering apparatus, comprising:
a slab having a first surface; and
a plurality of optical elements in or on said first surface of said slab, the plurality of optical elements comprising at least one liquid crystal on silicon element, wherein
the optical beam steering apparatus is arranged such that at least one optical beam can propagate substantially freely in the slab from one optical element of said plurality of optical elements to another optical element of said plurality of optical elements via a reflection from a second surface of the optical beam steering apparatus.

2. An optical beam steering apparatus according to claim 1, wherein the at least one liquid crystal on silicon element is an array of liquid crystal on silicon elements.

3. An optical beam steering apparatus according to claim 1, wherein the or each liquid crystal on silicon element is a holographic element.

4. An optical beam steering apparatus according to claim 3, comprising a reconfigurable hologram having a plurality of said liquid crystal on silicon elements.

5. An optical beam steering apparatus according to any one of the preceding claims claim 1, wherein the slab is formed of any one of glass, ULE 7971, acrylic, silicon, quartz or borofloat.

6. An optical beam steering apparatus according claim 1, wherein the one optical element from which said at least one optical beam can propagate substantially freely in the slab is a liquid crystal on silicon element.

7. An optical beam steering apparatus according to claim 1, wherein the second surface is a surface of the slab.

8. An optical beam steering apparatus according to claim 1, wherein the slab is a pentaprism.

9. An optical beam steering apparatus according to claim 1, wherein the second surface is a surface of the slab, the second surface being curved to reflect a beam toward one of said elements.

10. An optical beam steering apparatus according to claim 1, wherein the second surface is a curved mirror arranged to reflect a beam received at the mirror from the slab toward one of said optical elements in or on said first surface.

11. An optical beam steering apparatus according to claim 1, wherein the apparatus has:
a substrate formed of a semiconductor material;
a panel formed of light-transmitting material, the panel being said slab; and
a layer of liquid crystal located in a gap defined between said substrate and said panel, wherein:
at least at a first region of said substrate, substrate electrical contacts are formed in electrical communication with electronic circuit components formed in or on said substrate; and
at least at a first region of said panel, corresponding to said first region of the substrate, panel electrical contacts are formed,
wherein said substrate electrical contacts and said panel electrical contacts oppose each other and are electrically connected to each other by a rigid electrical connection.

12. An optical add drop multiplexer for optical beam steering, comprising an optical beam steering apparatus according to any claim 1.

13. Optical add drop multiplexer for optical beam steering according to claim 12, wherein the optical add drop multiplexer is reconfigurable.

14. Method of manufacturing an optical beam steering apparatus, the optical beam steering apparatus being as defined in claim 1, the method comprising the steps of:
positioning the plurality of optical elements in or on the first surface of the slab using one or more of robotics placement, flip-chip technology and printing, such that light from a predetermined one of said plurality of optical elements can be reflected from the second surface towards another predetermined one of said plurality of optical elements.

15. Method of manufacturing an optical beam steering apparatus of claim 14, further comprising polishing a second surface of the slab.

16. A reconfigurable optical drop multiplexer for selective wavelength switching in a wavelength division multiplex system, comprising:
a slab having a plurality of surfaces and having disposed on said surfaces:
an input port for receiving an input wavelength division multiplex signal;
a wavelength splitter for separating wavelength channels of said input wavelength division multiplex signal;
a drop port for transmitting one or more wavelength channels;
an output port for transmitting an output wavelength division multiplex signal; and
a plurality of liquid crystal on silicon elements arranged to reflect wavelength channels separated by said splitter to the output port and the drop port according to a control signal;
and
at least one reflecting surface arranged to reflect said wavelength channels of said input wavelength division multiplex signal,
wherein:
the reconfigurable optical add drop multiplexer is arranged to allow said wavelength channels of said input wavelength division multiplex signal to propagate substantially freely in the slab from the input port to the drop and output ports via said plurality of liquid crystal on silicon elements and the at least one reflecting surface.
